(19) United States
(12) Patent Application Publication
(10) Pub. No.: US 2025/0263055 A1
(43) Pub. Date: Aug. 21, 2025

(54) ACTUATING DEVICE FOR A RAIL BRAKING SYSTEM AND RAIL VEHICLE PROVIDED WITH SUCH AN ACTUATING DEVICE

(71) Applicant: WABTEC HAUTS-DE-FRANCE, AMIENS (FR)

(72) Inventors: Stéphane LESAGE, Amiens (FR); Claudino GONCALVES, Ribeaucourt (FR)

(73) Assignee: WABTEC Hauts-de-France, Amiens (FR)

(21) Appl. No.: 18/856,531

(22) PCT Filed: Apr. 11, 2023
(86) PCT No.: PCT/FR2023/050520

§ 371 Date: Oct. 11, 2024

(30) Foreign Application Priority Data
Apr. 12, 2022 (FR) FR2203328

(51) Int. Cl. B60T 13/66; B60T 7/10; B60T 13/68; B60T 17/22; B61H 13/02

(52) U.S. Cl. CPC B60T 13/665; B60T 7/102; B60T 13/683; B60T 17/228; B61H 13/02

(57) ABSTRACT

The invention relates to an actuating device (4) having a control mechanism (13) having at least one rotatable cam cylinder (110) which is provided with at least one contact face (111) having a predetermined profile, said contact face being designed to act directly on at least one predetermined contact module (100a-j) according to the direction of rotational movement of said at least one cam cylinder and the position of said actuating device; and a module-holder (150) mounted in a given position at least partially around the cam cylinder, the contact modules being mechanically attached to the module-holder and facing the at least one contact face of the cam cylinder.

### TECHNICAL FIELD OF THE INVENTION

The invention relates to the field of rail vehicle braking. More specifically, it relates to a control device-type actuating device provided to control a braking system for a rail vehicle. It also relates to the rail vehicles that have such devices.

### PRIOR ART

Rail vehicles are generally fitted with service brake cylinders having a service brake piston which can move under the effect of a pressurised fluid, the movement of this piston resulting in a braking action such as a brake disk being squeezed between two linings, or the direct pressure of a brake pad against a wheel of the vehicle. These brake cylinders also generally have a parking or emergency brake which is activated, for example, in the event of loss of pressure in the pressurised fluid and/or in the event of deliberate venting or leakage of the pneumatic system. These cylinders are often supplied by a pneumatic line, which can originate in a so-called main or general line or in a so-called auxiliary tank, which is itself supplied by the main or general line.

Such rail braking systems with a service brake, parking brake and/or emergency brake are actuated and controlled by a driver of the rail vehicle thanks to dedicated actuating devices which are arranged on an instrument panel of the vehicle and which can, for example, be mechanical and/or electrical and/or pneumatic.

There are actuating devices, also known as brake control devices, which are designed to operate the brakes on rail vehicles and to control the pneumatic line in the event of an emergency, for example when the normal actuating device for the service brake malfunctions.

Such control devices can have five positions, more generally between three and twelve positions, including a neutral central position, two braking positions upstream of the neutral central position and two brake release positions downstream of the neutral central position, i.e. opposite the two braking positions.

The control device can have a first braking position and a first brake release position which respectively allow to gradually brake and release the brakes of the vehicle, as long as the driver maintains the respective first position.

When the driver moves the control device towards one of the first respective braking and brake release positions, a first brake or brake release valve is moved by a mechanism, thereby forming a first fluidic draining or supply path, respectively for gradual braking and gradual brake release, for the circulation of a pneumatic agent.

The control device can also have a second braking position and a second brake release position which respectively allow to brake and release the brakes of the vehicle very quickly.

When the driver moves the control device towards one of the second respective braking and brake release positions, a second brake or brake release valve, which is connected in series with the first respective valve, is moved by this first valve which is itself moved by the mechanism, thereby forming a second fluidic draining or supply path, respectively for quick braking and quick brake release, for the circulation of the pneumatic agent. It should be noted that the second fluidic path has a larger passage section for the pneumatic agent than that of the first fluidic path.

Patent application EP 3 666 310 describes such an actuating device, having a valve mechanism and a control mechanism designed to act on the valve mechanism. The actuating device is designed to accept at least one braking position in which the valve mechanism acts on at least one brake valve of the valve mechanism to actuate the rail braking system to brake the rail vehicle, and/or a brake release position in which the valve mechanism acts on at least one brake release valve of the valve mechanism to actuate the rail braking system to release the brakes of the rail vehicle. The control mechanism has at least one rotatable cam wheel which is provided with at least one contact face having a predetermined profile. The contact face is designed to act directly on the brake valve or on the brake release valve according to the direction of rotational movement of the cam wheel and the position of the actuating device.

### Disclosure of the Invention

The invention relates to a control device-type actuating device provided to control a braking system for a rail vehicle, with even better performance compared to the aforementioned control device in the prior art, whilst being simple, convenient and cost-effective.

According to a first aspect, the object of the invention is therefore an actuating device for a rail braking system for a rail vehicle with brakes with at least one brake lining or with at least one brake pad, having a plurality of contact modules and a control mechanism designed to act on the contact modules; which control mechanism comprises at least one rotatable cam cylinder which is provided with at least one contact face having a predetermined profile, said contact face being designed to act directly on at least one predetermined contact module according to the direction of rotational movement of said at least one cam cylinder and the position of said actuating device; and said actuating device has a module-holder mounted in a given position at least partially around the cam cylinder, at least said contact modules being mechanically attached to the module-holder and facing the at least one contact face of the cam cylinder.

The use of a rotatable cam cylinder which is provided with a predetermined profile on a contact face, in combination with a module-holder to which a plurality of contact modules are attached, has the advantage of providing precise angular indexing of the various positions of the actuating device and making the actuating device scalable in that it is possible to add and/or remove functions in a particularly simple manner by modifying the number of contact modules and adapting the outer face of the cam cylinder.

Simple, convenient and cost-effective preferred features of the device according to the invention are set out below.

The actuating device is designed to accept at least one braking position in which the control mechanism acts on a braking contact module which sends a braking instruction to actuate said rail braking system to brake said rail vehicle and/or at least one brake release position in which the control mechanism acts on a brake release contact module which sends a brake release instruction to actuate said rail braking system to release the brakes of said rail vehicle.

The actuating device is designed to accept a plurality of positions and it has several predetermined modules juxtaposed on a first side of the module-holder and/or several other predetermined modules juxtaposed on a second side of the module-holder opposite the first side, and said at least one cam cylinder is designed to act directly on said predetermined modules according to the direction and angle of rotational movement of said cam cylinder and the position of said actuating device among the plurality of positions.

Said predetermined profile of said contact face of said cam cylinder can have at least one protrusion and at least one recess which are respectively provided to actuate and disengage said predetermined modules.

The cam cylinder be rotatably mounted on the module-holder.

The cam cylinder can have an overall longitudinal shape extending between a first end wall and a second end wall opposite the first end wall, with the contact face being formed on an at least partially cylindrical wall extending between the first end wall and the second end wall.

The cam cylinder can have windows formed in the at least partially cylindrical wall so as to form two opposite main areas of the contact face.

The device can have a control lever mechanically attached to said control mechanism and which can be put into a plurality of selectable positions, which positions can be stable or unstable positions.

The control mechanism can have a lever support to which the lever is mechanically attached, with the lever support having a projecting mounting rod and a recessed positioning notch, and the cam cylinder can have an overall longitudinal shape extending between a first end wall and a second end wall opposite the first end wall, and have a positioning pin protruding from the first end wall and designed to be inserted into the positioning notch of the lever support, and a mounting hole formed in the first end wall and designed to receive the mounting rod of the lever support.

The device can have a housing from which the control mechanism protrudes and the module-holder can have a base mechanically attached to the housing and a frame extending longitudinally from the base to a distal wall of the module-holder, the frame substantially surrounding the contact face of the cam cylinder and having one or more lateral openings for inserting the contact modules through the frame and facing the contact face of the cam cylinder.

The cam cylinder can be rotatably mounted on the base of the module-holder.

The cam cylinder can have an overall longitudinal shape extending between a first end wall and a second end wall opposite the first end wall, with the contact face being formed on an at least partially cylindrical wall extending between the first end wall and the second end wall, the first end wall of the cam cylinder cooperating with the base of the module-holder and the second end wall of the cam cylinder cooperating with the distal wall of the module-holder.

The device can have rotational guide members interposed between the first end wall of the cam cylinder and the base of the module-holder and between the second end wall of the cam cylinder and the distal wall of the module-holder.

The cam cylinder can have windows formed in the at least partially cylindrical wall and the frame can have one or more upper and lower openings located opposite the windows of the cam cylinder in a neutral position of the actuating device.

The contact modules can be mechanically attached to the frame of the module-holder.

The module-holder can be provided with a retaining member mechanically attached on one side to the base of the module-holder and on the other side to the distal wall of the module-holder and extending from the base to the distal wall, surrounding the contact modules.

The actuating device can also comprise a wheel mechanically attached to the cam cylinder and located at a distance from the module-holder.

The wheel can be a cam wheel, which, like the cam cylinder, is rotatable and which is provided with at least one contact face having a predetermined profile, said contact face being designed to act directly on a brake valve or on a brake release valve of the actuating device according to the direction of rotational movement of the cam wheel and the position of the actuating device.

The cam cylinder and/or the wheel can be provided with angular stops to limit their rotation in the two directions of rotational movement.

The cam cylinder and the wheel can be formed in a single piece.

The device can comprise a feedback mechanism designed to act on the wheel when it is rotated from a neutral position to a braking or brake release position, either to return it to its neutral position or to hold it in its braking or brake release position.

The feedback mechanism can have a return member acting on a support member designed to come into contact with a feedback face of the wheel, the feedback face having a predetermined complementary profile enabling the wheel to be returned to or held in its neutral position or its braking or brake release position respectively.

The feedback mechanism can have a cap and a ring between which the return member is interposed.

The return member can be formed by a spring which bears against the cap and against a first side of said ring.

The spring can be adjustable.

The support member can be formed by a ball, or by an assembly formed by a cage and one or more rollers inserted into the cage and partially housed on a second side of said ring, opposite its first side.

The predetermined complementary profile of the feedback face of the wheel can have at least one ramped wall and at least one recess which are respectively provided to return the wheel to or hold it in the neutral position or the braking or brake release position respectively.

The feedback face can be formed on a contour wall of the wheel.

According to a second aspect, the object of the invention is also a range of actuating devices as described above, of which at least two actuating devices are provided with a distinct number of contact modules.

According to a third aspect, the object of the invention is also a rail vehicle with brakes with at least one brake lining or with at least one brake pad, comprising at least one rail braking system designed to act on said at least one brake lining or said at least one brake pad of said rail vehicle, as well as an actuating device as described above.

### BRIEF DESCRIPTION OF THE FIGURES

The disclosure of the invention will now be continued with the description of exemplary embodiments, provided below by way of example and in a non-limiting manner, with reference to the accompanying drawings.

FIG. 1 schematically and partially shows a rail vehicle provided with a braking system and an actuating device designed to control the braking system.

FIG. 2 is an isolated perspective view of the actuating device, according to a first embodiment.

FIG. 3 is a similar view to that in FIG. 2, showing a side view of the device.

FIG. 4 is a similar view to those in FIGS. 2 and 3, showing a top view of the device.

FIG. 5 is a perspective semi-exploded view of the actuating device.

FIG. 6 is a similar view to that in FIG. 5, taken from a different viewing angle.

FIG. 7 is an isolated perspective view of a cam of the actuating device.

FIG. 8 is a front view of the actuating device according to a first configuration.

FIG. 9 is a front view of the actuating device according to a second configuration.

FIG. 10 is a similar view to that in FIG. 2, showing the actuating device with a different number of contact modules.

FIG. 11 is a similar view to those in FIGS. 2 and 10, showing the actuating device with yet another number of contact modules.

FIG. 12 is a similar view to those in FIGS. 2, 10 and 11, showing the actuating device with yet another number of contact modules.

FIG. 13 is a partial view of the actuating device, showing an exploded perspective of a pneumatic part thereof.

FIG. 14 is a similar view to that in FIG. 2, taken from a different viewing angle and in accordance with a first embodiment of the actuating device.

FIG. 15 is a similar view to that in FIG. 14 showing a second embodiment of the actuating device.

FIG. 16 is a perspective semi-exploded view of the actuating device in accordance with a second embodiment, without the pneumatic part.

FIG. 17 is a perspective semi-exploded view of the actuating device in accordance with a third embodiment.

### DETAILED DESCRIPTION

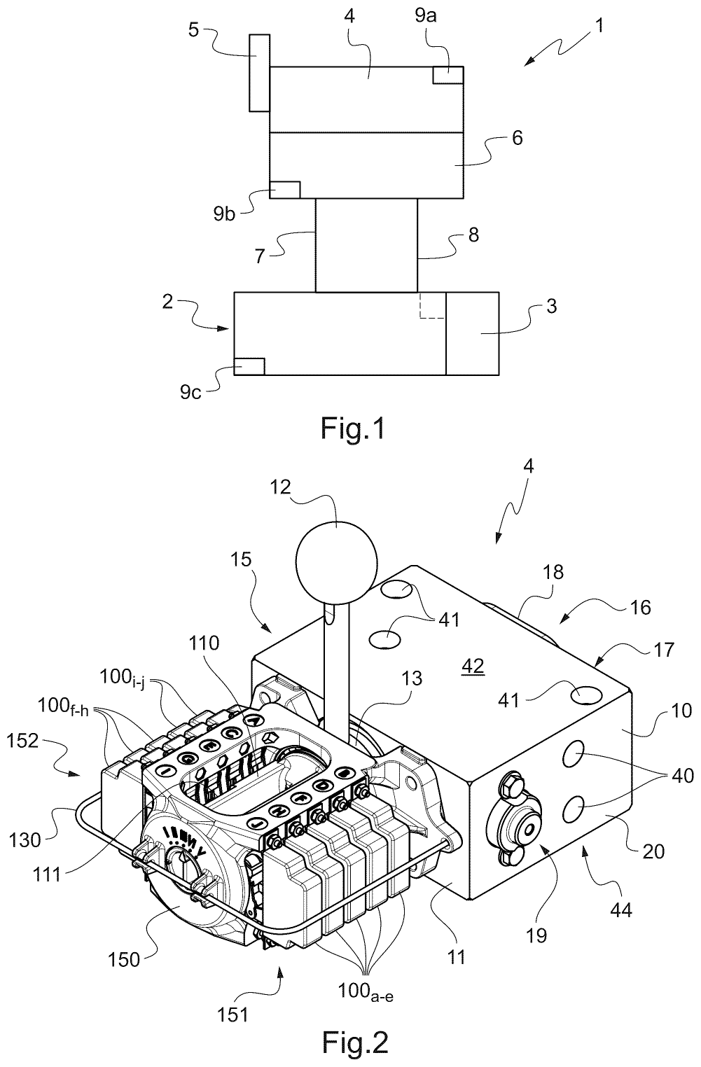

FIG. 1 shows in a highly schematic manner a rail vehicle 1 with brakes with brake linings or with brake pads, provided with a rail braking system 2 having in particular service brake cylinders 3 provided to act on the brake linings or brake pads.

The rail vehicle 1 also has an actuating device, hereinafter referred to as control device 4, designed to control via a lever 5 of the control device 4 the rail braking system 2 and its service brake cylinders 3 in particular with the aim of braking and/or releasing the brakes of the rail vehicle 1.

The control device 4 can also be designed to control the rail braking system 2 via the lever 5 of the control device 4 with the aim of performing functions other than braking or releasing the brakes of the rail vehicle 1. For example, it could be a function for indicating a braking and/or brake release action, or a safety function, a position detection function, an electric and/or pneumatic service braking function, an electric and/or pneumatic and/or analogue emergency braking function, a so-called direct braking function in electric mode and/or in analogue mode, a wheel cleaning control function, or even a wheel sanding function, etc.

The control device 4 and the rail braking system 2 are components of a rail braking installation for the vehicle 1. The control device 4 is fixed here to a support 6 forming a distribution interface between the control device 4 and the rail braking system 2.

In the example shown, the installation is pneumatic and has a main line 7 which is connected, for example, on the one hand to the inlet of the control device 4 and designed to supply the latter with a pneumatic agent and, on the other hand, to the rail braking system 2; as well as a general line 8 which is, for example, connected to the outlet of the control device 4 and designed to supply the rail braking system 2 with this pneumatic agent.

Alternatively, the installation may not have a general line.

In addition to being pneumatic, the installation is also electric, with, for example, a communication interface having a first transmitter/receiver 9a housed in the control device 4 and a second transmitter/receiver 9b housed, for example, on the support 6 and/or a third transmitter/receiver 9c arranged on the cylinder 3.

With reference to FIG. 2, the control device 4 has a housing formed by a body 10 having, for example, an overall parallelepiped shape.

The control device 4 has a control mechanism 13 which partially protrudes from a front face 11 of the body 10, as well as a control lever 12 mechanically attached to the control mechanism 13.

The control lever 12 can be actuated by a user and can be put into a plurality of selectable positions.

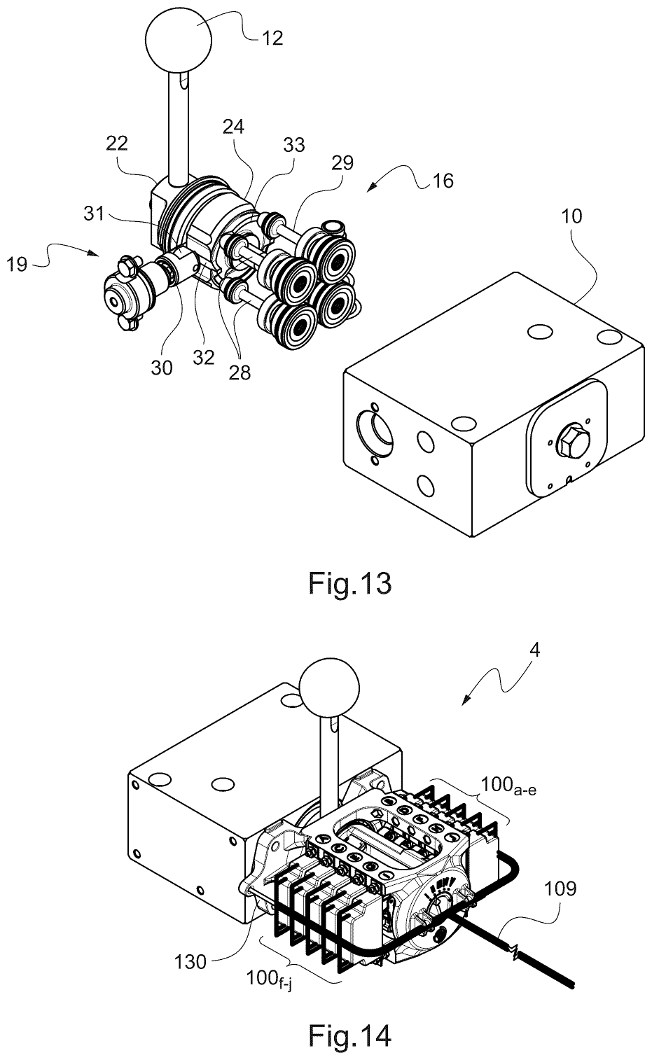

In the example shown, the control device 4 has a pneumatic part and in particular a valve mechanism 16, described in detail with reference to FIG. 13, housed inside the body 10 and which can be accessed via a hatch 18 fixed to a rear face 17 of the body 10 which is opposite its front face 11.

The control device 4 also has a feedback mechanism 19, described in detail with reference to FIG. 13, mounted inside the body 10 and which can be accessed via a cap 21 housed in a second lateral face 20 of the body 10 which is opposite a first lateral face 15.

The control device 4 is provided with mounting holes 41, three of them here for example, formed in the body 10 and provided to receive fixing screws for mounting the control device 4 on the support 6 forming the distribution interface between the control device 4 and the rail braking system 2.

These mounting holes 41 open at a first end at a top face 42 of the body 10 and, at a second end opposite the first end, at a bottom face 44 of the body 10, opposite its top face 42.

In the example shown, the control device 4 is also provided with braking channels 40 in fluid communication with the valve mechanism 16.

The control device 4 is also provided with a plurality of contact modules 100a-j on which the control mechanism 13 is designed to act.

In the example shown, each of the contact modules 100a-j is connected via a wired and/or wireless connection with the first transmitter/receiver 9a housed in the control device 4, which is designed to communicate with one and/or the other of the second transmitter/receiver 9b and the third transmitter/receiver 9c.

The contact modules 100a-j can thus send instructions to the first transmitter/receiver 9a, which can then transmit and/or process them.

In particular, the control device 4 is designed here to accept at least one braking position in which the control mechanism 13 acts on a braking contact module, for example 100a, which sends a braking instruction to actuate the rail braking system 2 and in particular to actuate its service brake cylinders 3 to brake the rail vehicle and/or at least one brake release position in which the control mechanism 13 acts on a brake release contact module, for example 100f, which sends a brake release instruction to actuate the rail braking system 2 and in particular to actuate its service brake cylinders 3 to release the brakes of the rail vehicle.

The control mechanism 13 has in this case a cam cylinder 110 which can be rotated under the action of the control lever 12 and is provided with at least one contact face 111 having a predetermined profile designed to act directly on the braking contact module 100a or on the brake release contact module 100f according to the direction of rotational movement of the lever 12 and therefore of the cam cylinder 110, corresponding to a selectable position of the control device 4.

More generally, depending on the selected position of the control device 4 among the plurality of positions, the contact face 111 of the cam cylinder 110 comes into contact with one or more respective contact modules among the contact modules 100a-j with the aim of performing a predefined function of the control device 4.

The control device 4 has a module-holder 150 mounted in a given position at least partially around the cam cylinder 110, the braking contact modules 100a-j being mechanically attached to the module-holder 150 and facing the contact face 111 of the cam cylinder 110.

The cam cylinder 110 is rotatably mounted here on the module-holder 150.

The control device 4 is designed here to accept a plurality of braking and/or brake release positions, or even other functions.

Thus, the contact modules 100a-j are juxtaposed on a first side 151 of the module-holder 150 and on a second side 152 opposite the first side 151, and the cam cylinder 110 is designed to act directly on them according to the direction and angle of rotational movement of the lever 12.

The module-holder 150 can be provided with a retaining member 130, formed here by a wire element, such as a semi-rigid cable, which surrounds the contact modules 100a-j.

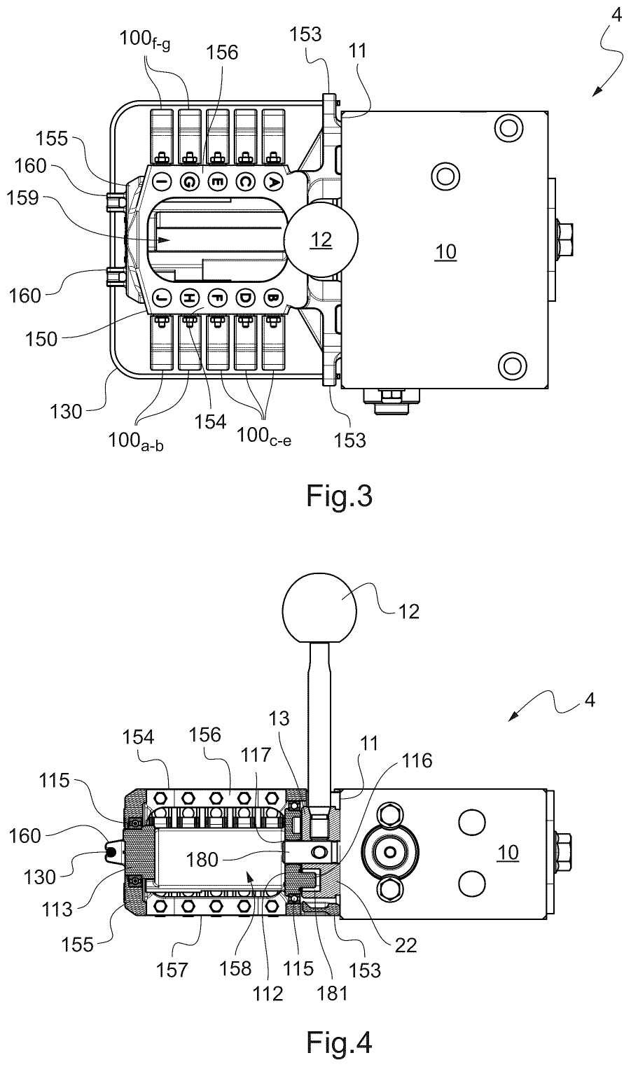

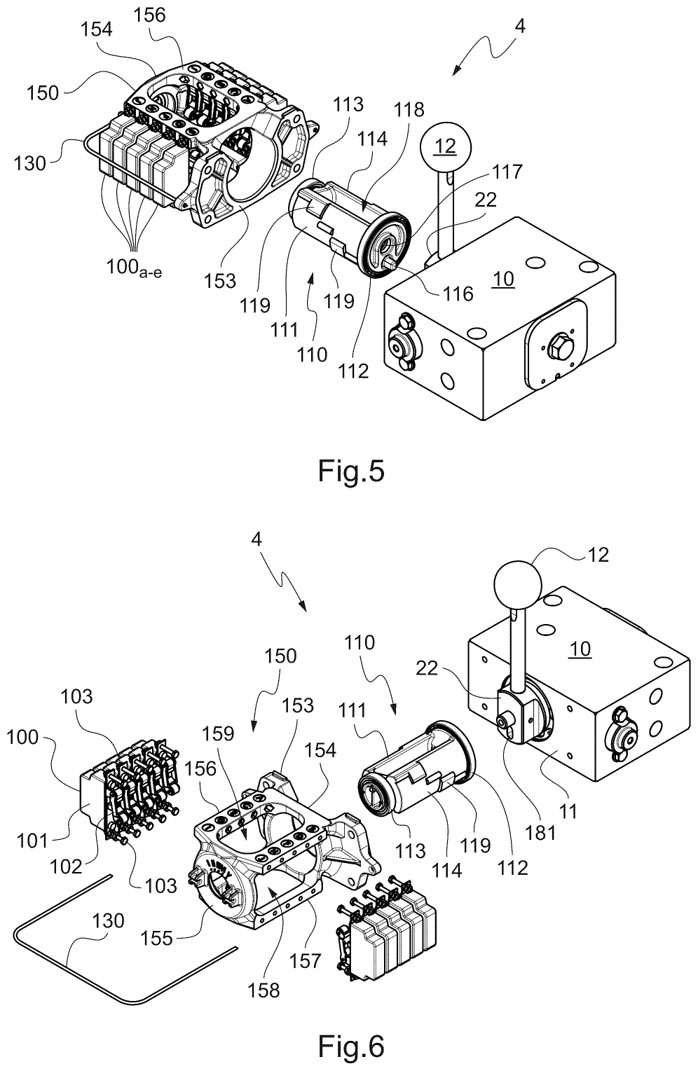

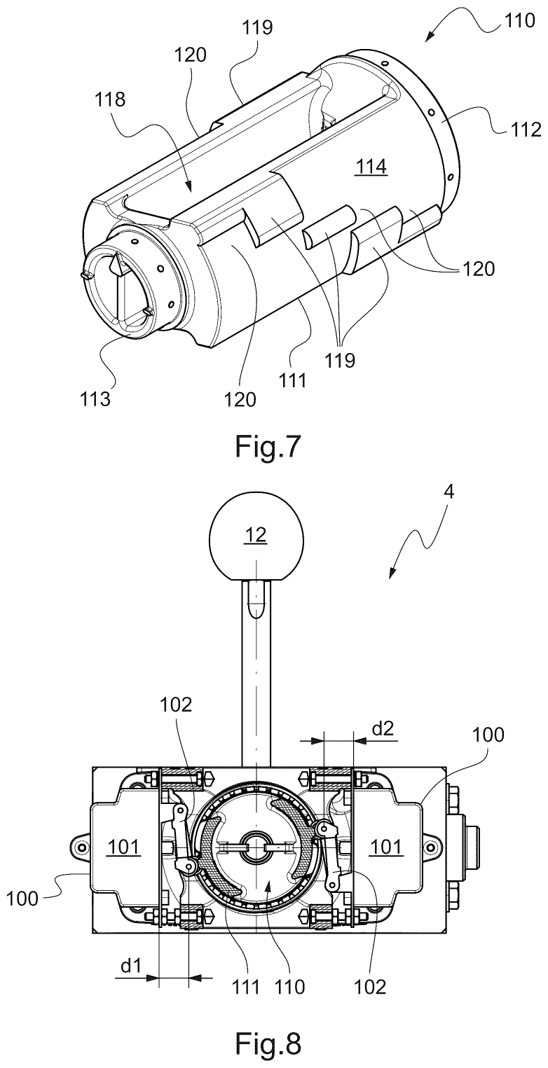

The control mechanism 13 and the module-holder 130 will be described in more detail in cooperation with the housing 10 and the contact modules 100a-j with reference to FIGS. 3 to 7.

The assembly formed by the control mechanism 13, the module-holder 130 and the contact modules 100a-j overall extends longitudinally protruding from the front face 11 of the body 10 of the housing.

The module-holder 150 is formed by a base 153 mechanically attached to the front face 11 of the body 10 of the housing.

It should be noted that the cam cylinder 110 is rotatably mounted here on the base of the module-holder 150.

The module-holder 150 is also formed by a frame 154 extending longitudinally from the base 153 to a distal wall 155 of the module-holder 150.

It should be noted that the frame 154 is designed here to substantially surround the contact face 111 of the cam cylinder 110.

In particular, the frame 154 has an upper wall 156 connected to the base 153 and to the distal wall 155 and a lower wall 157 opposite the upper wall 156 and also connected to the base 153 and to the distal wall 155.

The frame 154 has several lateral openings 158 here formed on the first and second sides 151 and 152 of the module-holder 150 to enable the contact modules 100a-j to be inserted through the frame 154 and facing the contact face 111 of the cam cylinder 110.

The frame 154 also has upper and lower openings 159 here.

In the example shown, the contact modules 100a-j are mechanically attached to the frame 154 of the module-holder 150.

For example, the contact modules 100a-j have fixing screws 103 passing through them which engage on the upper wall 156 and on the lower wall 157 of the frame 154.

The contact modules 100a-j are electrical or electromechanical contactors here, provided with an electrical box 101 and a contact member 102 protruding from the electrical box 101.

The attachment of the contact modules 100a-j can be adjustable so as to be able to move them relative to the frame 154 and thus move the respective contact members 102 towards or away from the contact face 111 of the cam cylinder 110.

The retaining member 130 is mechanically attached here, on the one hand, by its ends to the base 153 and, on the other, to hooks 160 protruding from the distal wall 155, in a direction opposite to the base 153.

In the example shown, the control mechanism 13 has a lever support 22 protruding from the front face 11 of the body 10 and to which the lever 12 is attached.

The lever support 22 has a projecting mounting rod 180 here and a recessed positioning notch 181.

The cam cylinder 110 is mechanically secured in rotation to the lever support 22.

The cam cylinder 110 has a substantially longitudinal shape extending here between a first end wall 112 and a second end wall 113 opposite the first end wall 112.

The contact face 111 is formed on an at least partially cylindrical wall 114 extending between the first end wall 112 and the second end wall 113.

The first end wall 112 is designed here to cooperate with the base 153 of the module-holder 150 and the second end wall 113 is designed here to cooperate with the distal wall 155 of the module-holder 150.

Rotational guide members 115, such as bearings, are interposed between the first end wall 112 of the cam cylinder 110 and the base 153 of the module-holder 150 and between the second end wall 113 of the cam cylinder 110 and the distal wall 155 of the module-holder 150.

The cam cylinder 110 has a positioning pin 116 protruding from the its first end wall 112 and designed to be inserted into the positioning notch 181 of the lever support 22.

The cam cylinder 110 also has a mounting hole 117 formed in its first end wall 112 and designed to receive the mounting rod 180 of the lever support 22.

The cam cylinder 110 has windows 118 here formed in the at least partially cylindrical wall 114 so as to form two opposite main areas of the contact face 111.

In the example shown, it should be noted that in a neutral position of the control device 4, the upper and lower openings 159 of the frame 154 are located opposite the windows 118 of the cam cylinder 110.

The contact face 111 of the cam cylinder 110 has a predetermined profile on each of the main areas separated by the windows 118.

The predetermined profile is formed here by protrusions 119 followed by recesses 120.

The recesses 120 are in the same plane here as the at least partially cylindrical wall 114.

Alternatively, the recesses can be recessed into this wall.

The protrusions 119 form indentations which are designed here respectively to disengage the contact modules 100a-j, including the braking and brake release modules 100a and 100f, by coming into contact with their respective contact members 102.

The recesses 120 enable these same contact modules 100a-j to be actuated by moving away from their respective contact members 102.

Alternatively, the protrusions can actuate the contact modules and the recesses can disengage the contact modules.

It should be noted that each of the aforementioned elements, including in particular the cam cylinder 110 and the module-holder 150 can be made of plastic or any other material, and for example by carrying out a moulding, machining or additive manufacturing method.

The use of a rotatable cam cylinder 110 which is provided with a predetermined profile on its contact face 111, in combination with a module-holder 150 to which the plurality of contact modules 100a-j are attached, has the advantage of providing precise indexing of the various positions of the control device 4 and making it scalable in that it is possible to add and/or remove functions in a particularly simple manner by modifying the number of contact modules 100a-j and adapting the outer face 111 of the cam cylinder 107.

Adapting the outer face 111 of the cam cylinder 107 means determining a profile in line with the number of desired positions of the lever 12 and therefore the number of contact modules 100a-j. For example, the number and position of protrusions 119 and recesses 120 on the at least partially cylindrical wall 114 to form the contact face 111 can vary.

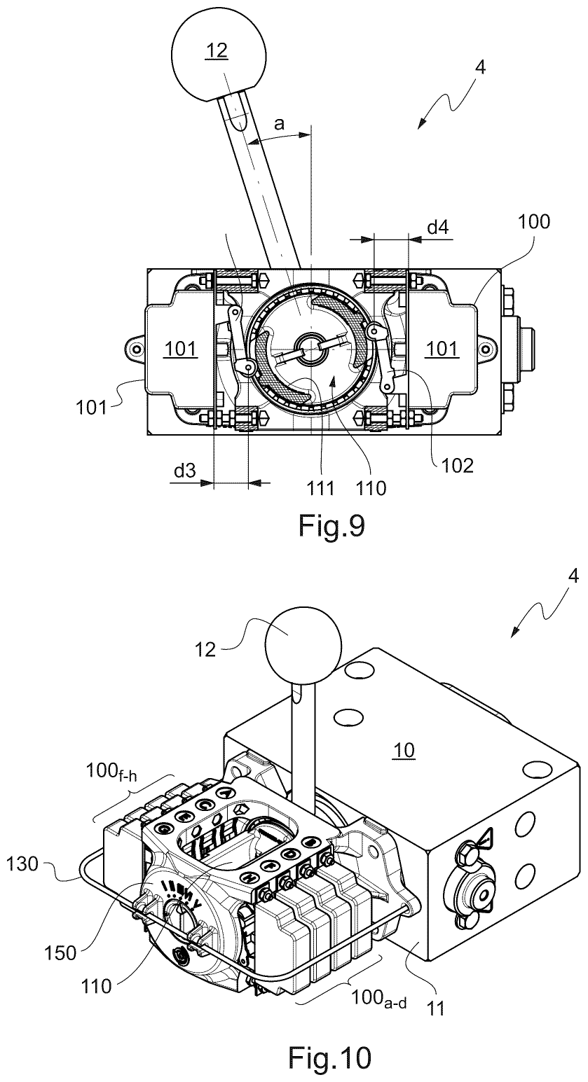

FIGS. 8 and 9 simply illustrate two positions of the lever 12 offset by an angle a, one called a neutral position (FIG. 8) and the other a braking position (FIG. 9).

Actuating the lever 12 results in the rotation of the lever support 22 and therefore the cam cylinder 110 inside the module-holder 150.

In FIG. 8, in the neutral position, protrusions from the contact face 111 bear against the contact members 102 of at least certain contact modules 100a-j, which do not send an instruction to perform one or more braking, brake release or other functions.

FIG. 8 shows contact members 102 which are acted on and which are at distances d1 and d2 from their respective housing 101.

In FIG. 9, in the braking position, these same protrusions from the contact face 111 move away and release the contact members 102 of at least certain contact modules 100a-j, which send at least one instruction to apply braking and possibly instructions relating to other functions.

FIG. 9 shows contact members 102 which are no longer acted on and which are at distances d3 and d4, respectively greater than d1 and d2, from their respective housing 101.

FIGS. 10 to 12, in combination with FIG. 2, show a range of control devices 4 which differ by the number of contact modules they have and therefore the number of functions that can be performed by selecting the positions of the lever 12.

In FIG. 2, the control device 4 is provided with ten contact modules 100a-j.

In FIG. 10, the control device 4 is provided with eight contact modules 100a-h, with four contact modules on each side of the module-holder 150, which is the right size, just like the retaining member 130 and the cam cylinder 110.

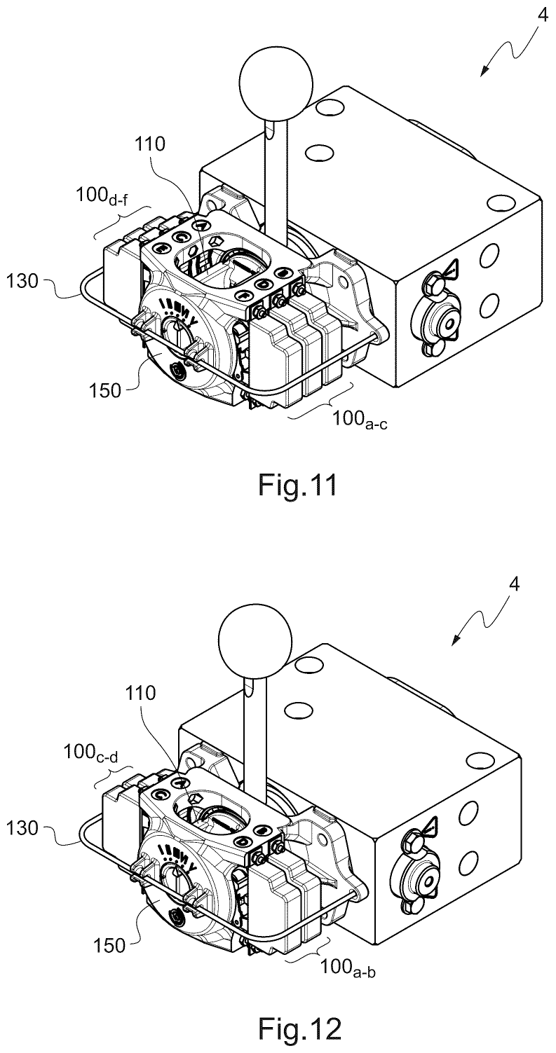

In FIG. 11, the control device 4 is provided with six contact modules 100a-f, with three contact modules on each side of the module-holder 150, which is the right size, just like the retaining member 130 and the cam cylinder 110.

In FIG. 12, the control device 4 is provided with four contact modules 100a-d, with two contact modules on each side of the module-holder 150, which is the right size, just like the retaining member 130 and the cam cylinder 110.

FIG. 13 shows, on the one hand, a wheel 24, in this case a cam wheel, which is mechanically attached to the lever support 22 to which the lever 12 is attached, opposite the cam cylinder (not shown in this figure), the valve mechanism 16 and the feedback mechanism 19 with which the wheel 24 cooperates.

This wheel 24 is housed here in the body 10 of the housing and is substantially similar to the one described in the prior art with reference to patent application EP 3 666 310 such that only a brief description will be provided.

This wheel 24 can be designed to act on the valve mechanism 16 depending on the position of the lever 12.

In particular, the wheel 24 is rotatable and is provided with at least one contact face having a predetermined profile. The contact face is designed to act directly on a brake valve 28 or on a brake release valve 29 according to the direction of rotational movement of the wheel 24.

The valves 28 and 29 are structurally identical to the ones described in the aforementioned patent application and fluid flow channels are provided according to the position of the valves.

The wheel 24 has a front face 33 which is provided with a predetermined profile and designed to act directly on the valves 28, 29 so as to open and close them.

Of course, the actuation of the valves 28 and 29 must be designed to match the actuation of the contact modules described above, or else the control device is designed to give priority to one or other of the electrical and pneumatic parts.

The wheel 24 can be provided with angular stops to limit their rotation in the two directions of rotational movement.

The wheel 24 is separate here from the cam cylinder.

The feedback mechanism 19 designed here to act on the wheel 24 when it is rotated from a neutral position to a braking or brake release position, either to return it to its neutral position or to hold it in its braking or brake release position.

The feedback mechanism 19 can have a return member 30 acting on a support member 31 designed to come into contact with a feedback face 32 of the wheel 24, the feedback face having a predetermined complementary profile enabling the wheel 24 to be returned to or held in its neutral position or its braking or brake release position respectively.

The support member is an assembly here formed by a cage and one or more rollers inserted into the cage and partially housed on a second side of said ring, opposite its first side.

The feedback mechanism 19 can have a cap and a ring between which the return member 30 is interposed.

The return member 30 can be formed by an adjustable spring which bears against the cap and against a first side of said ring.

The predetermined complementary profile of the feedback face 32 of the wheel 24 can have at least one ramped wall and at least one recess which are respectively provided to return the wheel 24 to or hold it in the neutral position or the braking or brake release position respectively.

The feedback face 32 can be formed on a contour wall of the wheel 24.

FIG. 14 shows a first embodiment of the control device 4, which differs simply in that the contact modules 100a-j are connected by a wired connection 109, for example, to the first transmitter/receiver housed in the control device 4, or directly to one and/or the other of the second transmitter/receiver and the third transmitter/receiver.

The wired connection 109 runs here along the retaining member 130 and joins each of the contact modules 100a-j.

The contact modules 100a-j can thus send instructions via this wired connection 109.

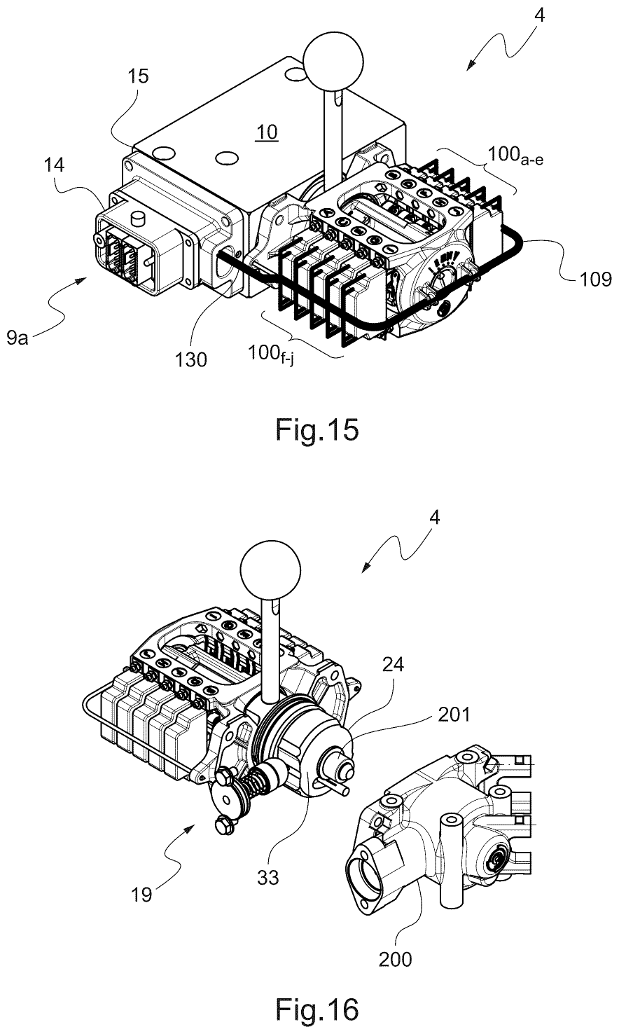

FIG. 15 shows a second embodiment of the control device 4, which differs simply in that the contact modules 100a-j are also connected by a wired connection 109, which is directly connected here to an electrical connection system 14 which is mounted on the first lateral face 15 of the body 10 and which forms, for example, the first transmitter/receiver 9a.

FIG. 16 is a perspective semi-exploded view of the control device 4 in accordance with a second embodiment, without the pneumatic part.

The housing has a body 200 different in shape and size from the one described above.

The control device 4 is provided with a control mechanism 13 similar to the one described above with reference in particular to FIGS. 2 to 15 except that the wheel 24 does not have a profile on its front face 33 but rather a positioning and guiding pin 201 designed to be housed in a complementary hole (not shown) of the body 200.

In addition, the control device 4 has a feedback mechanism 19 which is provided here with a ball system, like the one described in patent application EP 3 666 310.

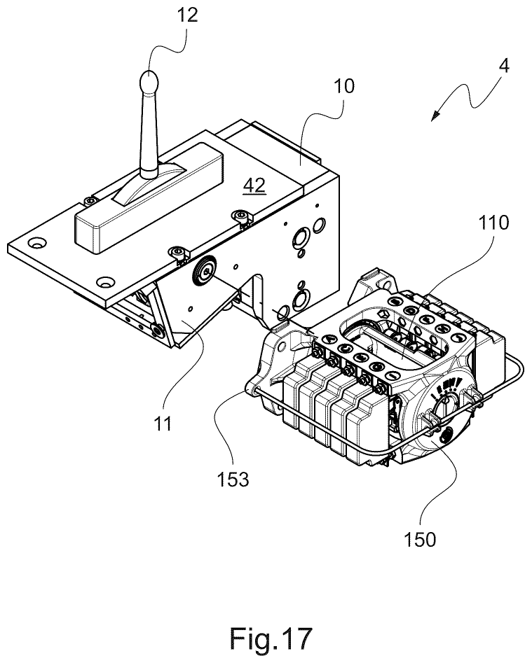

FIG. 17 is a perspective semi-exploded view of the control device 4 in accordance with a third embodiment in which the lever 12 is integrated into the body 10 of the housing and protrudes from its top face 42 rather than from its front face 11. The lever support (not shown) is thus integrated into the body 10 rather than protruding from the front face 11. The base 153 of the module-holder 150 and the cam cylinder 110 are directly mounted on the front face 11.

Alternatives that are not illustrated are set out below.

The cam cylinder and the wheel can be formed in a single piece.

The control device can have more or fewer contact modules.

The cam cylinder and/or the module-holder may not have windows and/or upper and lower openings.

The module-holder can have a frame with a different shape, for example circular and/or closed.

A plurality of cam cylinders can be mounted on a same module-holder, or conversely a plurality of module-holders can support a cam cylinder.

The cam cylinder can have a plurality of sections connected to one another and extending longitudinally.

The first end wall of the cam cylinder can be designed to cooperate with the base of the module-holder and the second end wall of the cam cylinder can be designed to cooperate with an intermediate wall of the module-holder, which is different from the distal wall of the module-holder, which intermediate wall can be located between the base and the distal wall of the module-holder.

The bearings can be replaced by plastic or metal rings or the cam cylinder can be in direct contact with the module-holder.

The control device may not have a retaining member.

The control lever can be made entirely or only partially of metal, or of plastic, or of a composite material, or even include an electrically insulating portion, in particular of glass fibre, at one free end of the lever or interposed between two opposite end portions.

The installation can be all-electric rather than electric and pneumatic.

More generally, the invention is not limited to the examples described and illustrated.

1. Actuating device for a rail braking system for a rail vehicle with brakes with at least one brake lining or with at least one brake pad, having a plurality of contact modules and a control mechanism designed to act on the contact modules, which control mechanism comprises at least one rotatable cam cylinder which is provided with at least one contact face having a predetermined profile, said contact face being designed to act directly on at least one predetermined contact module according to the direction of rotational movement of said at least one cam cylinder and the position of said actuating device; and said actuating device has a module-holder mounted in a given position at least partially around the cam cylinder, the contact modules being mechanically attached to the module-holder and facing the at least one contact face of the cam cylinder.

2. The device according to claim 1, wherein it is designed to accept at least one braking position in which the control mechanism acts on a braking contact module which sends a braking instruction to actuate said rail braking system to brake said rail vehicle and/or at least one brake release position in which the control mechanism acts on a brake release contact module which sends a brake release instruction to actuate said rail braking system to release the brakes of said rail vehicle.

3. The device according to claim 1, further configured to accept a plurality of predetermined positions and it has several predetermined modules juxtaposed on a first side of the module-holder and/or several other predetermined modules juxtaposed on a second side of the module-holder opposite the first side, and said at least one cam cylinder is designed to act directly on said predetermined modules according to the direction and an angle of rotational movement of said cam cylinder and the position of said actuating device among the plurality of positions.

4. The device according to one of claim 1, wherein the predetermined profile of said contact face of said cam cylinder has at least one protrusion and at least one recess which are respectively provided to actuate and disengage said contact modules.

5. The device according to claim 1, wherein the cam cylinder is rotatably mounted on the module-holder.

6. The device according to claim 1, wherein the cam cylinder has an overall longitudinal shape extending between a first end wall and a second end wall opposite the first end wall, with the contact face being formed on an at least partially cylindrical wall extending between the first end wall and the second end wall.

7. The device according to claim 6, wherein the cam cylinder has windows formed in the at least partially cylindrical wall so as to form two opposite main areas of the contact face.

8. The device according to claim 1, further comprising a control lever mechanically attached to said control mechanism and which can be put into a plurality of selectable positions.

9. The device according to claim 8, wherein the control mechanism comprises a lever support to which the lever is mechanically attached, with the lever support having a projecting mounting rod and a recessed positioning notch (181), and the cam cylinder has an overall longitudinal shape extending between a first end wall and a second end wall opposite the first end wall, and has a positioning pin protruding from the first end wall and designed to be inserted into the positioning notch of the lever support, and a mounting hole formed in the first end wall and designed to receive the mounting rod of the lever support.

10. The device according to claim 1, further comprising a housing from which the control mechanism protrudes and the module-holder has a base mechanically attached to the housing and a frame extending longitudinally from the base to a distal wall of the module-holder, the frame substantially surrounding the contact face of the cam cylinder and having one or more lateral openings for inserting the contact modules through the frame and facing the contact face of the cam cylinder.

11. The device according to claim 10, wherein the cam cylinder is rotatably mounted on the base of the module-holder.

12. The device according to claim 10, wherein the cam cylinder has an overall longitudinal shape extending between a first end wall and a second end wall opposite the first end wall, with the contact face being formed on an at least partially cylindrical wall extending between the first end wall and the second end wall, the first end wall cooperating with the base of the module-holder and the second end wall cooperating with the distal wall of the module-holder.

13. The device according to claim 12, further comprising rotational guide members interposed between the first end wall of the cam cylinder and the base of the module-holder and between the second end wall of the cam cylinder and the distal wall of the module-holder.

14. The device according to claim 10, wherein the cam cylinder has windows formed in the at least partially cylindrical wall and the frame of the module-holder has one or more upper and lower openings located opposite the windows of the cam cylinder in a neutral position of the actuating device.

15. The device according to claim 10, wherein the contact modules are mechanically attached to the frame of the module-holder.

16. The device according to claim 10, wherein the module-holder is provided with a retaining member mechanically attached on one side to the base of the module-holder and on the other side to the distal wall of the module-holder and extending from the base to the distal wall, surrounding the contact modules (100a-j).

17. The range of actuating devices according to claim 1, wherein at least two actuating devices are provided with a distinct number of contact modules.

18. A rail vehicle with brakes with at least one brake lining or with at least one brake shoe, having a rail braking system designed to act on said at least one brake lining or said at least one brake pad of said rail vehicle, as well as an actuating device according to claim 1.
